(19) United States
(12) Patent Application Publication
(10) Pub. No.: US 2016/0154551 A1
(43) Pub. Date: Jun. 2, 2016

(54) SYSTEM AND METHOD FOR COMPARATIVE TIME-TO-COMPLETION DISPLAY VIEW FOR QUEUED E-READING CONTENT ITEMS

(71) Applicant: KOBO INCORPORATED, Toronto (CA)

(72) Inventor: Inae HEO, North York (CA)

(73) Assignee: KOBO INCORPORATED, Toronto (CA)

(21) Appl. No.: 14/556,632

(22) Filed: Dec. 1, 2014

(51) Int. Cl. G06F 3/0483; G06F 3/0482; G06F 3/0484; G06F 3/0481

(52) U.S. Cl. CPC G06F 3/0483; G06F 3/04817; G06F 3/0482; G06F 3/04842

(57) ABSTRACT

Method and system for displaying e-reading items in a reading queue according to word count of the items in order to allow a user to make determinations on what to read next based on reading time available. The method is executed in a processor of a computing device, the computing device further including a memory storing instructions and a display screen. The method comprises accessing a reading queue comprising a plurality of e-books, ones of the plurality of e-books including word content; for respective ones of the e-books in the reading queue, determining a word count of the word content; calculating a spatial area of an iconic representation for the ones of the plurality of e-books, the spatial area being calculated in proportion to the respective word counts, and displaying the iconic representations of the e-books of the reading queue in a comparative view.

### TECHNICAL FIELD

Examples described herein relate to a system and method for a reading progress indicator.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from, or coupled to, but distinct from the electronic personal display itself. Some examples of electronic personal displays include mobile digital devices/tablet computers and electronic readers (e-readers) such (e.g., Apple iPad®, Microsoft Surface®, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, Kobo Aura H2O and the like).

Some electronic personal display devices are purpose built devices designed to perform especially well at displaying digitally-stored content for reading or viewing thereon. For example, a purpose build device may include a display that reduces glare, performs well in high lighting conditions, and/or mimics the look of text as presented via actual discrete pages of paper. While such purpose built devices may excel at displaying content for a user to read, they may also perform other functions, such as displaying images, emitting audio, recording audio, and web surfing, among others.

Electronic personal displays are among numerous kinds of consumer devices that can receive services and utilize resources across a network service. Such devices can operate applications or provide other functionality that links a device to a particular account of a specific service. For example, the electronic reader (e-reader) devices typically link to an online bookstore, and media playback devices often include applications that enable the user to access an online media electronic library (or e-library). In this context, the user accounts can enable the user to receive the full benefit and functionality of the device.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 illustrates a system utilizing applications and providing e-book services on a computing device configured for displaying a comparative view of digital content items comprising a user's reading queue.

FIG. 2 illustrates a schematic architecture of a computing device configured for displaying a comparative view of digital content items comprising a user's reading queue.

FIGS. 3(a) and (b) illustrate example configurations in an operation to displaying a comparative view of digital content items comprising a user's reading queue, according to some embodiments.

FIG. 4 illustrates a method of operating a computing device to construct and display a comparative view of digital content items comprising a user's reading queue.

### DETAILED DESCRIPTION

One or more embodiments described herein may be implemented using programmatic logic modules or components. A programmatic logic module or component may include a program, a subroutine, a portion of a program, or a software or a hardware component capable of performing one or more stated tasks or functions in conjunction with one or more processors. As used herein, a logic module or component can exist on a hardware component independently of other modules or components. Alternatively, a module or component can be a shared element or process of other modules or programs.

Furthermore, one or more embodiments described herein may be implemented through instructions that are executable by one or more processors. These instructions may be stored on a computer-readable non-transitory medium. In particular, the numerous computing and communication devices shown with embodiments of the invention include processor(s) and various forms of computer memory, including volatile and non-volatile forms, storing data and instructions. Examples of computer-readable mediums include permanent memory storage devices, such as hard drives on personal computers or servers. Other examples of computer storage mediums include portable storage units, flash or solid state memory (such as carried on many cell phones and consumer electronic devices) and magnetic memory. Computers, terminals, network enabled devices (e.g., mobile devices such as cell phones and wearable computers) are all examples of machines and devices that utilize processors, memory, and instructions stored on computer-readable mediums. Additionally, embodiments may be implemented in the form of computer-programs, or a computer usable storage medium capable of storing such a program.

“E-books” are a form of electronic publication content stored in digital format in a computer non-transitory memory, viewable on a computing device having display functionality. Pages of an e-book may be digitally constructed to correspond to, or mimic, the paginated format of a printed publication for viewing, such as provided by printed literary works (e.g., novels) and periodicals (e.g., magazines, comic books, journals, etc.), wherein discrete pages comprising the electronic text, word and/or image content are digitally constructed. Optionally, some e-books may have chapter designations for arranging the content, as well as include content that corresponds to graphics or images (e.g., such as in the case of magazines or comic books). Multi-function devices, such as cellular-telephony or messaging devices, can utilize specialized applications (e.g., specialized e-reading application software) to view e-books in a format that mimics the paginated printed publication. Still further, some devices (sometimes labeled as “e-readers”) can display digitally-stored content in a more reading-centric manner, while also providing, via a user input interface, the ability to manipulate that content for viewing, such as via discrete pages arranged sequentially by way of pagination corresponding to a normal reading progression, or flow, of text content therein.

An “e-reading device”, also referred to herein as an electronic personal display, can refer to any computing device that can display or otherwise render an c-book. By way of example, an e-reading device can include a mobile computing device on which an e-reading application can be executed to render content that includes e-books (e.g., comic books, magazines, etc.). Such mobile computing devices can include, for example, a multi-functional computing device for cellular telephony/messaging (e.g., feature phone or smart phone), a tablet computer device, an ultra-mobile computing device, or a wearable computing device with a form factor of a wearable accessory device (e.g., smart watch or bracelet, glass-wear integrated with a computing device, etc.). As another example, an e-reading device can include an e-reader device, such as a purpose-built device that is optimized for an e-reading experience (e.g., with E-ink displays).

Often, a user may have several new e-books in their e-library collection, with those new e-books arranged in some “to-be-read-next” designation or queue, apart from other e-books of the collection. It would be beneficial to a user at times to have a single view, “at-a-glance” depiction of how much reading time might be required to complete reading the items, in comparative or relative terms, to allow a user to make determinations on what item to read next based on their scheduled reading time or reading time as might become available.

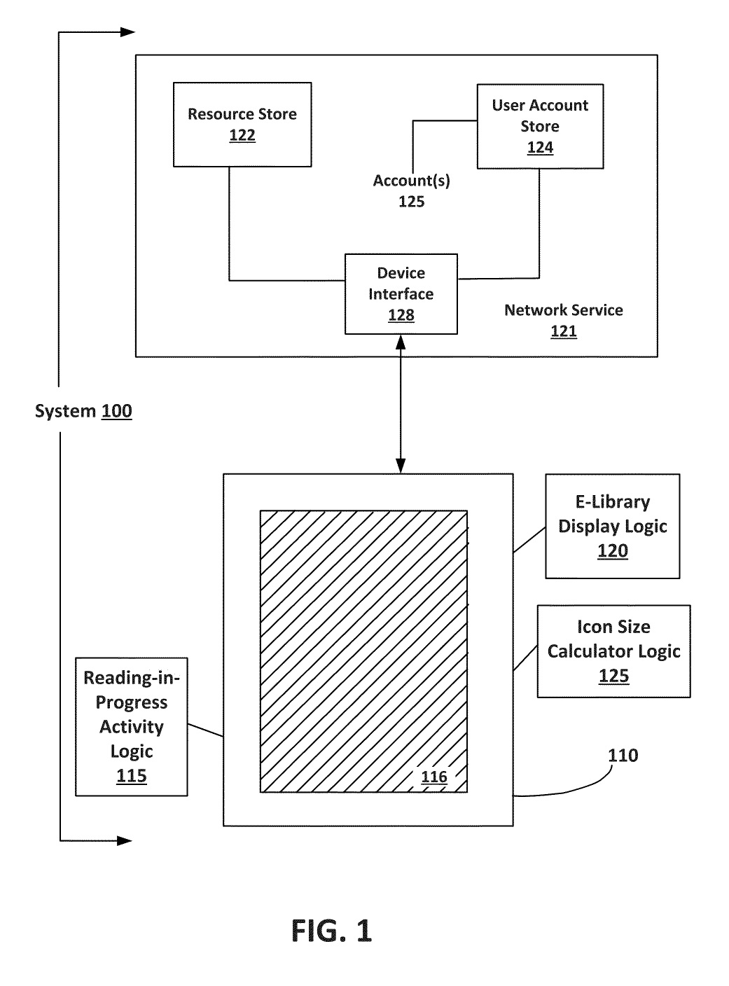

FIG. 1 illustrates a system 100 for utilizing applications and providing e-book services on a computing device, according to an embodiment. In an example of FIG. 1, system 100 includes an electronic personal display device, shown by way of example as an e-reading device 110, and a network service 121. The network service 121 can include multiple servers and other computing resources that provide various services in connection with one or more applications that are installed on the e-reading device 110. By way of example, in one implementation, the network service 121 can provide e-book services that communicate with the e-reading device 110. The e-book services provided through network service 121 can, for example, include services in which e-books are sold, shared, downloaded and/or stored. More generally, the network service 121 can provide various other content services, including content rendering services (e.g., streaming media) or other network-application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can run an e-reader application that links the device to the network service 121 and enables e-books provided through the service to be viewed and consumed. In another implementation, the e-reading device 110 can run a media playback or streaming application that receives files or streaming data from the network service 121. By way of example, the e-reading device 110 can be equipped with hardware and software to optimize certain application activities, such as reading electronic content (e.g., e-books). For example, the e-reading device 110 can have a tablet-like form factor, although variations are possible. In some cases, the e-reading device 110 can also have an E-ink display.

In additional detail, the network service 121 can include a device interface 128, a resource store 122 and a user account store 124. The user account store 124 can associate the e-reading device 110 with a user and with an account 125. The account 125 can also be associated with one or more application resources (e.g., e-books), which can be stored in the resource store 122. The device interface 128 can handle requests from the e-reading device 110, and further interface the requests of the device with services and functionality of the network service 121. The device interface 128 can utilize information provided with a user account 125 in order to enable services, such as purchasing downloads or determining what e-books and content items are associated with the user device. Additionally, the device interface 128 can provide the e-reading device 110 with access to the content store 122, which can include, for example, an online store. The device interface 128 can handle input to identify content items (e.g., e-books), and further to link content items to the account 125 of the user.

Yet further, the user account store 124 can retain metadata for individual accounts 125 associated with digital content items such as e-books that have been purchased or made available for consumption for a given account. The metadata may include text content information such as book title, author, summary, reviews and a total word count and/or page count of the e-book. The metadata may also include imagery associated with e-book, such as an image copy of a counterpart paper version book from publisher sources, mimicking the appearance of the counterpart paper book as might be displayed for marketing in a retail store.

The e-reading device 110 may be associated with the user account 125, and multiple devices may be associated with the same account. As described in greater detail below, the e-reading device 110 can store resources (e.g., e-books) that are purchased or otherwise made available to the user of the e-reading device 110, as well as to archive e-books and other digital content items that have been purchased for the user account 125, but are not stored on the particular computing device, but rather at an electronic library (e-library) associated with account 125.

With reference to an example of FIG. 1, e-reading device 110 can include a display 116. In an embodiment, the display 116 is touch-sensitive, to process touch inputs including gestures (e.g., swipes). For example, the display 116 may be integrated with one or more touch sensors to provide a touch-sensing region on a surface of display 116. For some embodiments, the one or more touch sensors may include capacitive sensors that can sense or detect a human body's capacitance as input. In the example of FIG. 1, the touch-sensing region coincides with a substantial surface area, if not all, of the display 116. Additionally, the housing can also be integrated with touch sensors to provide one or more touch sensing regions, for example, on the bezel and/or back surface of the housing.

According to some embodiments, the e-reading device 110 includes display sensor logic to detect and interpret user input or user input commands made through interaction with the touch sensors. By way of example, display sensor logic can detect a user making contact with the touch-sensing region of the display 116, otherwise known as a touch event. More specifically, display sensor logic can detect a touch event also referred to herein as a tap, an initial tap held in sustained contact, or sufficiently in proximity to register a “contact”, with display 116 (otherwise known as a “long press”), multiple taps performed either sequentially or generally simultaneously, swiping gesture actions made through user interaction with the touch sensing region of the display 116, or any combination of these gesture actions. Furthermore, the display sensor logic can interpret such interactions in a variety of ways. For example, each such interaction may be interpreted as a particular type of user input associated with a respective input command, execution of which may trigger a change in state of display 116. The display sensor logic may also sense directionality of a user gesture action so as to distinguish between, for example, leftward, rightward, upward, downward and diagonal swipes along a surface portion of display 116 for the purpose of associating respective input commands therewith.

According to some embodiments, the e-reading device 110 includes display sensor logic to detect and interpret user input or user input commands made through interaction with display 116, otherwise known as a touch event. More specifically, the display sensor logic can detect a touch event, an initial tap held in sustained contact, or sufficiently in proximity to register a “contact”, with display 116 (otherwise known as a “long press”), multiple taps performed either sequentially or generally simultaneously, swiping gesture actions made through user interaction with the touch sensing region of the display 116, or any combination of these gesture actions, which may initiate a change in display state of display 116.

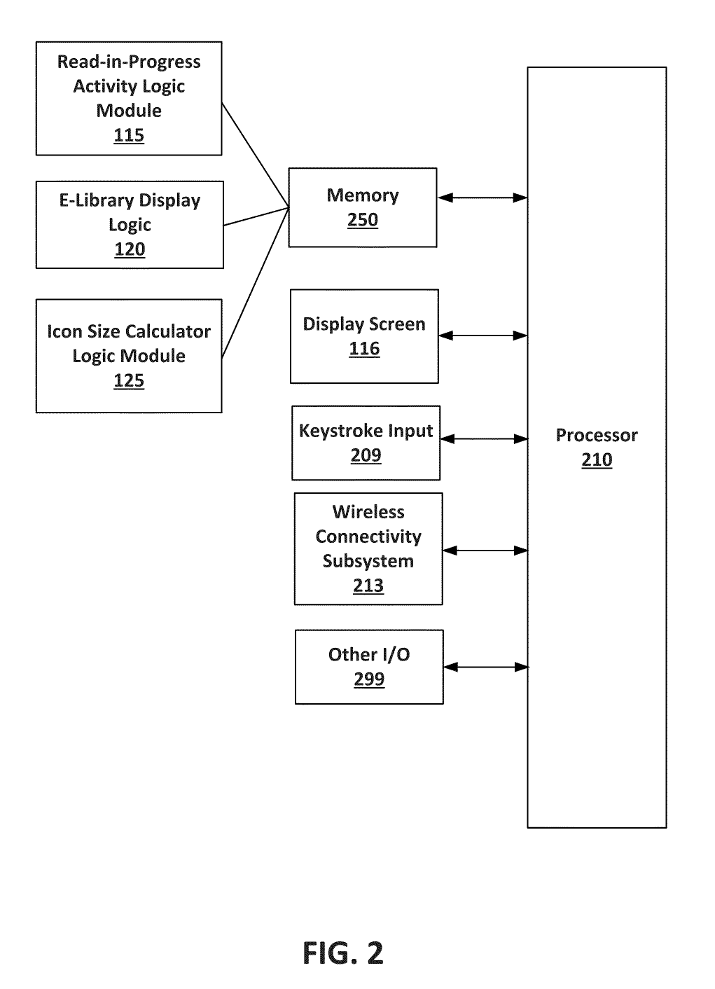

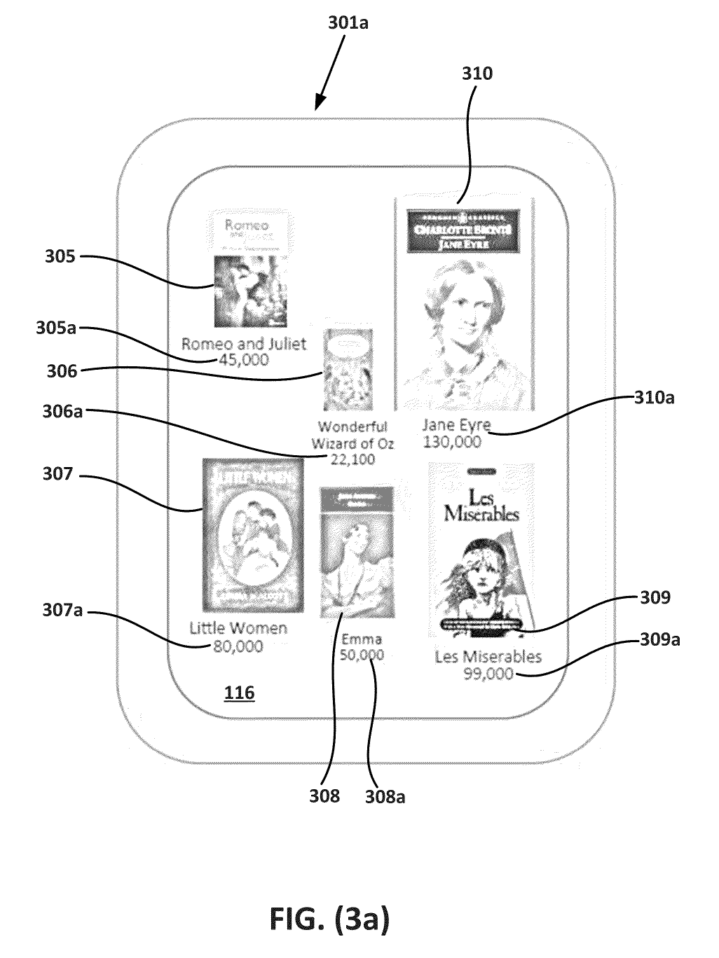

E-library display logic module 120, read-in-progress activity logic module 115 and icon size calculator logic 135 can be implemented as software modules comprising instructions stored in a memory of e-reading device 110, as described in further detail below with regard to FIG. 2.

FIG. 2 illustrates a schematic architecture of e-reading device 110 as described above with respect to FIG. 1. E-reading device 110 further includes processor 210, a memory 250 storing instructions and logic pertaining at least to e-library display logic 120, read-in-progress activity logic module 115 and icon size calculator logic 135.

Processor 210 can implement functionality using the logic and instructions stored in memory 250. Additionally, in some implementations, processor 210 utilizes the network interface 220 to communicate with the network service 121 (see FIG. 1). More specifically, the e-reading device 110 can access the network service 121 to receive various kinds of resources (e.g., digital content items such as e-books, configuration files, account information), as well as to provide information (e.g., user account information, service requests etc.). For example, e-reading device 110 can receive application resources 221, such as e-books or media files, that the user elects to purchase or otherwise download via the network service 121. The application resources 221 that are downloaded onto the e-reading device 110 can be stored in memory 250.

In some implementations, display 116 can correspond to, for example, a liquid crystal display (LCD) or light emitting diode (LED) display that illuminates in order to provide content generated from processor 210. In some implementations, display 116 can be touch-sensitive. For example, in some embodiments, one or more of the touch sensor components 138 may be integrated with display 116. In other embodiments, the touch sensor components 138 may be provided (e.g., as a layer) above or below display 116 such that individual touch sensor components 138 track different regions of display 116. Further, in some variations, display 116 can correspond to an electronic paper type display, which mimics conventional paper in the manner in which content is displayed. Examples of such display technologies include electrophoretic displays, electro-wetting displays, and electro-fluidic displays.

Processor 210 can receive, and respond to, input from various sources, including touch sensor components of display 116, keystroke input 208 such as from a virtual or rendered keyboard, and other input mechanisms 299 (e.g., buttons, mouse, microphone, etc.). In some embodiments, processor 210 responds to inputs in order to facilitate or enhance e-book activities such as generating e-book content on display 116, performing page transitions of the displayed e-book content, powering off e-reading device 110 and/or display 116, activating a screen saver, launching or closing an application, and/or otherwise altering a state of display 116.

E-reading device 110 further includes wireless connectivity subsystem 213, comprising a wireless communication receiver, a transmitter, and associated components, such as one or more embedded or internal antenna elements, local oscillators, and a processing module such as a digital signal processor (DSP) (not shown). As will be apparent to those skilled in the field of communications, the particular design of wireless connectivity subsystem 213 depends on the communication network in which c-reading device 110 is intended to operate, such as in accordance with Wi-Fi, Bluetooth, Near Field Communication (NFC) communication protocols, and the like.

Memory 250 may store e-books as respective records that include metadata and content. The content may be words of text content and also include images. The metadata may include text content information such as book title, author, summary, reviews and a total word count and/or page count of the e-book. The metadata may also include imagery associated with e-book, such as an image copy of a counterpart paper version book from publisher sources, mimicking the appearance of the counterpart paper book as might be displayed for marketing in a retail store.

Read-in-progress activity logic module 115, e-library display logic 120 and icon size calculator logic 135 can be implemented as software modules, comprising instructions stored in memory 250 on e-reading device 110. One or more embodiments of e-library display logic 120, icon size calculator logic 135 and read-in-progress activity logic module 115 described herein may be implemented using programmatic modules or components, a portion of a program, or software in conjunction with one or more hardware component(s) capable of performing one or more stated tasks or functions. As used herein, such module or component can exist on a hardware component independently of other modules or components. Alternatively, a module or component can be a shared element or process of other modules, programs or machines.

E-library display logic 120 may retrieve individual e-books or portions thereof for purposes of rendering via display 116. In an embodiment, e-library display logic 120 displays the e-library collections associated with a given user account in varied views, enabling “at a glance” viewing of e-books and related content stored therein. Whereas e-book content comprising the e-library collection may be stored variously locally in memory of e-reading device 110 and also remotely at user account store 124, e-library display logic 120 is able to show a comprehensive view of all e-books within the collection, in some embodiments, according to organization of those digital content items within the e-library. In one embodiment, e-library is able to display text titles and/or image icons representative of digital content items within the e-library collection that have been acquired but not yet read by the user. Yet further, e-library display logic 120 may arrange such “to be read” content items in a reading queue representation presented for display in a single view at display 116 of e-reading device 110.

Icon size calculator logic 135 serves to determine the size of the iconic representations of the digital content items of a reading queue of e-books for display within a single view at display 116. In one embodiment, icon size calculator logic 135 uses the word count of each e-book within the “to be read” reading queue to determine a size or spatial area of an icon representing respective e-books of the reading queue. For example, icon size calculator logic 135 may determine the word count of a given reading queue e-book content as comprising the total number of words contained in a content range from a beginning of a first chapter page through the end page of a last chapter. Then icon size calculator logic 135 calculates relative sizes of representative icons for each reading queue e-book in proportion to the respective word counts thereof. For instance, an e-book having twice as many words as another e-book may be rendered via a rectangular icon having twice the spatial area. In this manner, icons of the totality of e-books within a reading queue may be dynamically sized for presentation in a single comparative view according to their relative sizes or spatial areas.

Read-in-progress activity logic module 115 can track the reading progress with regard to any e-book currently being read within a given user account's c-library collection. In some embodiments, it may be advantageous for a user to include and see their partially-read e-books within their reading queue of “books to be read” view of their e-library as rendered at display 116 of e-reading device 110 by e-library display logic 120. This provides the user with the option to either continue reading and finish the read-in-progress e-book, or alternatively, start reading another new e-book within their “to be read” queue without re-engaging that read-in-progress e-book for now. For any e-book which the user may have started reading, read-in-progress activity logic module 115 can track the reading progress, for example in terms of word count or page count the user has completed reading versus the word count or page count remaining to be read in order for a user to finish reading the entire word count totality of which the e-book is comprised.

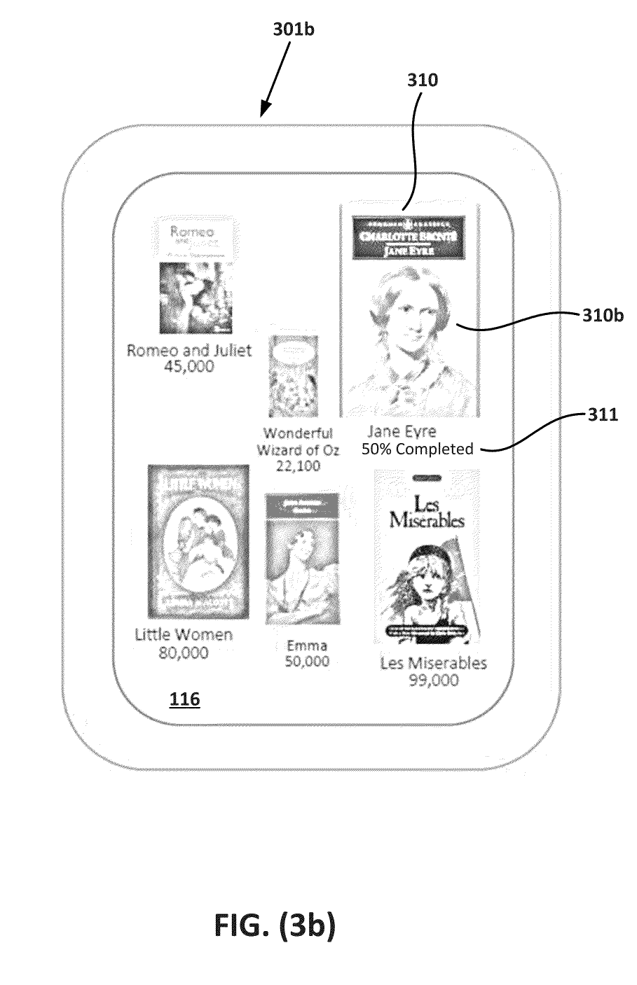

With reference now to FIG. 3(a) and FIG. 3(b), an embodiment implementation of e-library display logic 120 in conjunction with icon size calculator logic 135 and read-in-progress activity logic module 115 in operation of e-reading device 110 is described in further detail.

In FIG. 3(a), display 116 of e-reading device 110 renders comparative view 301a of e-books within a reading queue of a user account's e-library collection of digital content items. Representative icons 305-310 of e-books in the reading queue are depicted within comparative view 301 in proportion their respective word counts of word content respectively contained therein. In a further embodiment, words counts 305a through 310a may be depicted adjacent, or in association, with respective representative icons 305-310 of e-books comprising the reading queue.

FIG. 3(b) shows, in another embodiment, icon 310 representative of a read-in-progress rendered within the comparative view 301b of e-books of the reading queue of FIG. 3(a). While the overall size of the read-in-progress icon 310 is determined in proportion to total word count, in one embodiment, portion 310b representing the unfinished portion, yet to be read, comprises a spatial area determined in proportion to the word count of the unfinished reading portion 310b. In yet another embodiment, in contrast to other e-books of the comparative view 301, the unfinished portion 310b of read-in-progress icon 310 may be rendered in a pulsating or fluctuating color, “inviting” an observer to continue reading the content therein. For example, in one embodiment, the iconic representation of the read-in-progress e-book is rendered visually differently, which may include a difference in brightness, shading, color, pulsating aspect, or the like. In a further embodiment, a percentage completion metric 311 may be depicted adjacent, or in association, with representative read-in-progress icon 310, as calculated based on a word count proportion of already-read content versus a word count of content remaining to be read or word count remainder.

As depicted in FIGS. 3(a) and (b), representative icons 305-310 may depict an image of the front cover of the e-book that corresponds to, or mimics, a paper version of the book as published, for instant identification by way of confirmation to an observer or user.

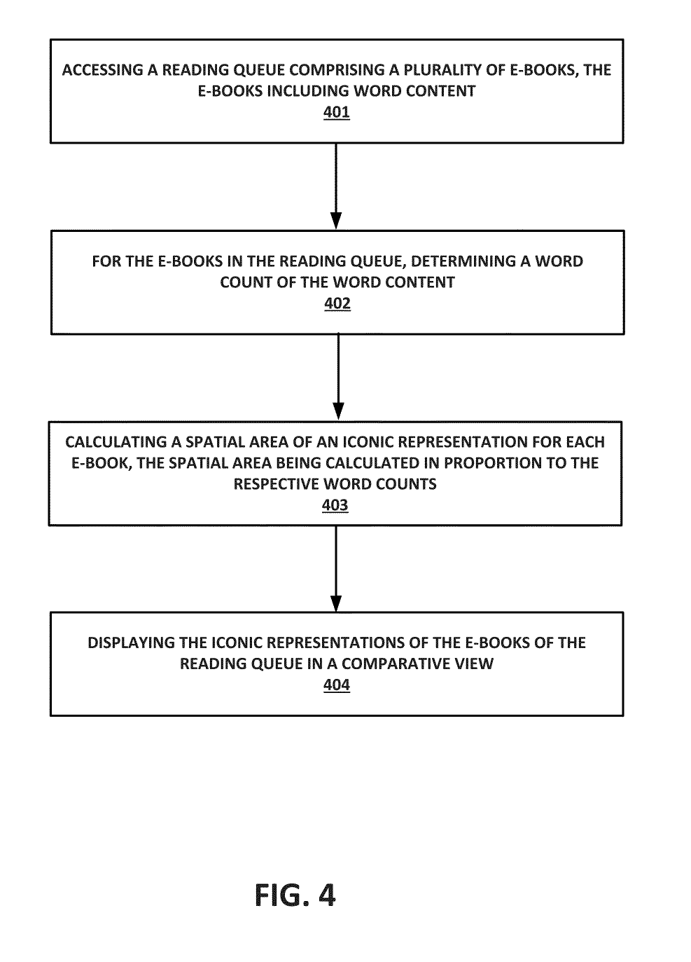

FIG. 4 illustrates an example method implemented by processor 210 of e-reading device 110 to provide an operation for displaying e-reading items in a reading queue using iconic representations sized according to word count of the items, in order to enable a user to make determinations on what to read next based on reading time available, according to an embodiment using elements such as described with prior examples, including those of FIGS. 1-3(b) herein.

At 401, one embodiment accesses a reading queue comprising a plurality of e-books, each of the e-books including word content.

At 402, for each of the e-books in the reading queue, one embodiment determines a word count of the word content.

At 403, one embodiment calculates a spatial area of iconic representations 505-510 for each e-book in the reading queue, the spatial area being determined based on proportionality of the e-book word counts.

At 404, one embodiment displays, in a comparative view 301a, 301b, the iconic representations 505-510 sized according to the calculated spatial areas of the e-books of the reading queue.

Although illustrative embodiments have been described in detail herein with reference to the accompanying drawings, variations to specific embodiments and details are contemplated and encompassed by this disclosure. For instance, the term e-book as used herein is intended to include e-magazines and e-comics. Further by way of example variations, although the word count of the e-book content is described above as comprising the total number of words contained in a range from a beginning of a first chapter page through the end page of a last chapter, it is contemplated that in other embodiments the word count of the e-book may alternatively be based on other ranges, such as for example, from a table of contents page through the end of the index table of the e-book.

It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method executed in a processor of a computing device, the computing device further including a memory storing instructions and a display screen, the method comprising:
accessing a reading queue comprising a plurality of e-books, ones of the plurality of e-books including word content;
for respective ones of the e-books in the reading queue, determining a word count of the word content;
calculating a spatial area of an iconic representation for the ones of the plurality of e-books, the spatial area being calculated in proportion to the respective word counts; and
displaying the iconic representations of the e-books of the reading queue in a comparative view.

2. The method of claim 1 wherein the iconic representation includes an image provided upon a cover of a counterpart paper book as published.

3. The method of claim 1 wherein the iconic representation is depicted with the word count of the respective e-books.

4. The method of claim 1 wherein the reading queue further includes a read-in-progress e-book having a percentage-completion, the percentage-completion based on a word count remainder to be read.

5. The method of claim 4 wherein an iconic representation of the read-in-progress e-book is displayed in the comparative view, the iconic representation including a spatial area calculated in accordance with the percentage-completion.

6. The method of claim 5 wherein the iconic representation of the read-in-progress e-book is depicted with the percentage completion.

7. The method of claim 5 wherein the iconic representation of the read-in-progress e-book is rendered visually differently than others in the comparative view.

8. The method of claim 7 wherein the visual difference is based on one of: a brightness, a shading, a color and a pulsating aspect.

9. The method of claim 1 wherein the comparative view is dynamically sized for display based on the plurality of e-books of the reading queue.

10. The method of claim 1 wherein the word count as determined includes the word content from a beginning chapter through an ending chapter for respective ones of the plurality of e-books of the reading queue.

11. A computer-readable medium that stores instructions for a computing device, the computing device including a processor, a memory and a display screen, the instructions being executable by the processor to cause the computing device to perform operations that include:
accessing a reading queue comprising a plurality of e-books, ones of the plurality of e-books including word content;
for respective ones of the e-books in the reading queue, determining a word count of the word content;
calculating a spatial area of an iconic representation for the ones of the plurality of e-books, the spatial area being calculated in proportion to the respective word counts; and
displaying the iconic representations of the e-books of the reading queue in a comparative view.

12. A computing device comprising:
a memory that stores a set of instructions;
a display screen;
a processor that access the instructions in memory, the processor further configured to:
access a reading queue comprising a plurality of e-books, ones of the plurality of e-books including word content;
for respective ones of the e-books in the reading queue, determine a word count of the word content;
calculate a spatial area of an iconic representation for the ones of the plurality of e-books, the spatial area being calculated in proportion to the respective word counts; and
display the iconic representations of the e-books of the reading queue in a comparative view.

13. The computing device of claim 12 wherein the iconic representation includes an image provided upon a cover of a counterpart paper book as published.

14. The computing device of claim 12 wherein the iconic representation is depicted with the word count of the respective e-books.

15. The computing device of claim 12 wherein the reading queue further includes a read-in-progress e-book having a percentage-completion, the percentage-completion based on a word count remainder to be read.

16. The computing device of claim 15 wherein an iconic representation of the read-in-progress e-book is displayed in the comparative view, the iconic representation including a spatial area calculated in accordance with the percentage-completion.

17. The computing device of claim 16 wherein the iconic representation of the read-in-progress e-book is depicted with the percentage completion.

18. The computing device of claim 15 wherein the iconic representation of the read-in-progress e-book is rendered visually differently than others in the comparative view.

19. The computing device of claim 18 wherein the visual difference is based on one of: a brightness, a shading, a color and a pulsating aspect.

20. The computing device of claim 12 wherein the comparative view is dynamically sized for display based on the plurality of e-books of the reading queue.

21. The computing device of claim 12 wherein the word count as determined includes the word content from a beginning chapter through an ending chapter for respective ones of the plurality of e-books of the reading queue.
